(19) United States
(12) Patent Application Publication
(10) Pub. No.: US 2026/0149833 A1
(43) Pub. Date: May 28, 2026

(54) HIGH LEVEL SYNTAX FOR LAYERED OBU VIDEO

(71) Applicant: Tencent America LLC, Palo Alto, CA (US)

(72) Inventors: Arianne HINDS, San Jose, CA (US); Stephan WENGER, Palo Alto, CA (US)

(73) Assignee: Tencent America LLC, Palo Alto, CA (US)

(21) Appl. No.: 19/366,424

(22) Filed: Oct. 22, 2025

Related U.S. Application Data
(60) Provisional application No. 63/726,236, filed on Nov. 27, 2024.

(51) Int. Cl. H04N 19/70; H04N 19/31; H04N 19/33; H04N 19/36

(52) U.S. Cl. CPC H04N 19/70; H04N 19/31; H04N 19/33; H04N 19/36

(57) ABSTRACT

Some aspects of the disclosure provide a method of video decoding. In an example, a coded video bitstream is received. The coded video bitstream includes coded information of one or more frames, the coded information of the one or more frames is encapsulated in open bitstream units (OBUs) that are structured into one or more layers. From the coded video bitstream, at least a first layer parameter set is parsed. The first layer parameter set includes a first set of syntax elements for coding first open bitstream units of a first layer in the one or more layers, the first set of syntax elements includes a first identifier identifying the first layer parameter set.

### INCORPORATION BY REFERENCE

The present application claims the benefit of priority to U.S. Provisional Application No. 63/726,236, filed on Nov. 27, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received. The coded video bitstream includes coded information of one or more frames, the coded information of the one or more frames is encapsulated in open bitstream units (OBUs) that are structured into one or more layers. From the coded video bitstream, at least a first layer parameter set is parsed. The first layer parameter set includes a first set of syntax elements for coding first open bitstream units of a first layer in the one or more layers, the first set of syntax elements includes a first identifier identifying the first layer parameter set.

Some aspects of the disclosure provide a method for video encoding. In an example, one or more frames are encoded into coded information in a bitstream, the coded information of the one or more frames is encapsulated in open bitstream units (OBUs) that are structured into one or more layers, first coded information in first open bitstream units of a first layer in the one or more layers is encoded according to a first layer parameter set. The first layer parameter set is encoded in the bitstream, the first layer parameter set includes a first set of syntax elements for coding the first open bitstream units of the first layer, the first layer parameter set includes a first identifier identifying the first layer parameter set.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a communication system in some examples.

FIG. 2 shows a block diagram of a video processing system in some examples.

FIG. 3 shows an exemplary block diagram of a video decoder in some examples.

FIG. 4 shows a block diagram of a video encoder in some examples.

FIG. 5 shows a layout of a coded video sequence in some examples.

FIG. 6 shows a layout of a video bitstream in some examples

FIG. 7 shows a layout of a layered open bitstream units based video bitstream in some aspects.

FIG. 8 shows a diagram of four categories of high-level syntax structures in some examples.

FIG. 9 shows an example of organizing the high level syntax information in some examples.

FIG. 10 shows an example of open bitstream unit sequence in some examples.

FIG. 11 shows a syntax structure of a layer parameter set in some examples.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

Some aspects of the disclosure provide techniques of video coding (e.g., encoding and decoding), such as techniques of the conveyance of metadata to a decoder regarding metadata that can be supported by the decoder for the purposes of supporting a particular application or producing a desired result for a display.

Video coding techniques can compress video data. In some examples, uncompressed digital video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

Video coding techniques (e.g., encoding and decoding techniques) can reduce redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

Video encoders and decoders can utilize techniques from several broad categories, including, for example, motion compensation, transform, quantization, and entropy coding, some of which will be introduced below.

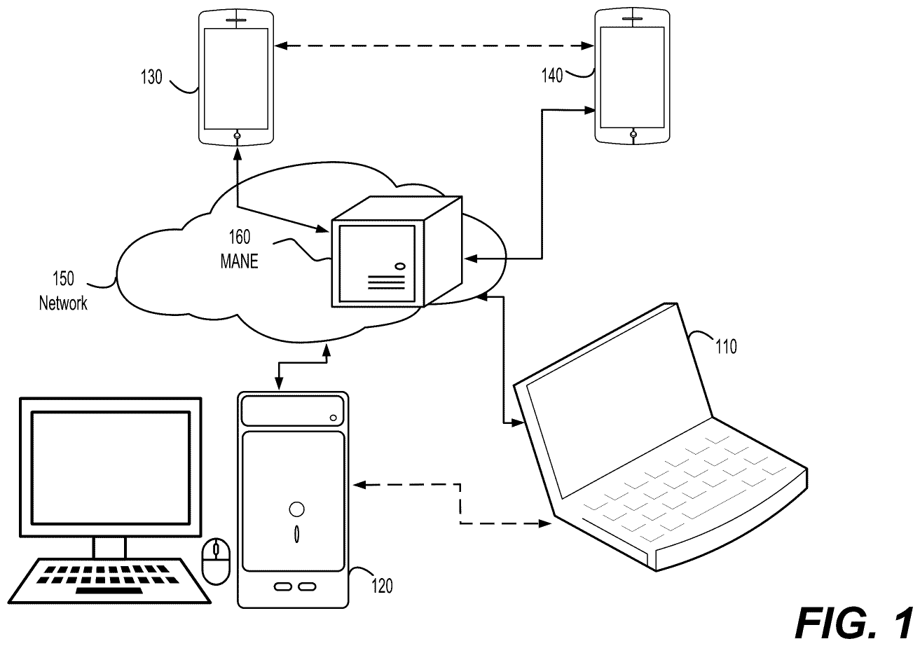

FIG. 1 shows a block diagram of a communication system (100) in some examples. The system (100) includes at least two terminals, such as a first terminal (110) and a second terminal (120) shown in FIG. 1, that are interconnected via a network (150). In some examples, unidirectional transmission of data is performed in the communication system (100). In an example, for the unidirectional transmission of data, the first terminal (110) can code video data at a local location for transmission to the second terminal (120) via the network (150). The second terminal (120) can receive the coded video data of the other terminal, such as the first terminal (110), from the network (150), decode the coded data and display the recovered video data. It is noted that unidirectional data transmission can be commonly used in media serving applications and the like.

FIG. 1 also shows a second pair of terminals, such as a third terminal (130) and a fourth terminal (140), that are configured to support bidirectional transmission of coded video that may occur, for example, during videoconferencing. For bidirectional transmission of data, each of the third terminal (130) and the fourth terminal (140) can code video data captured at a local location for transmission to the other terminal via the network (150). Each of the third terminal (130) and the fourth terminal (140) can also receive the coded video data transmitted by the other terminal, can decode the coded data and display the recovered video data at a local display device.

It is noted that while in FIG. 1, the terminals (110), (120), (130) and (140) are illustrated as servers, personal computers and smart phones, but the present disclosure is not limited to such terminal examples. Aspects of the present disclosure can include application with laptop computers, tablet computers, media players and/or dedicated video conferencing equipment. The network (150) represents any number of networks that convey coded video data among the terminals (110), (120), (130) and (140), including for example wireline and/or wireless communication networks. The network (150) can exchange data in circuit-switched and/or packet-switched channels. Representative networks include telecommunications networks, local area networks, wide area networks and/or the Internet. For the purposes of the present discussion, the architecture and topology of the network (150) can be immaterial to the operation of the present disclosure unless explained herein below. In some examples, the network (150) includes Media Aware Network Elements (MANEs, 160) that may be included in the transmission path between, for example, the third terminal (130) and fourth terminal (140). In some examples, a MANE (160) can selective forward of parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

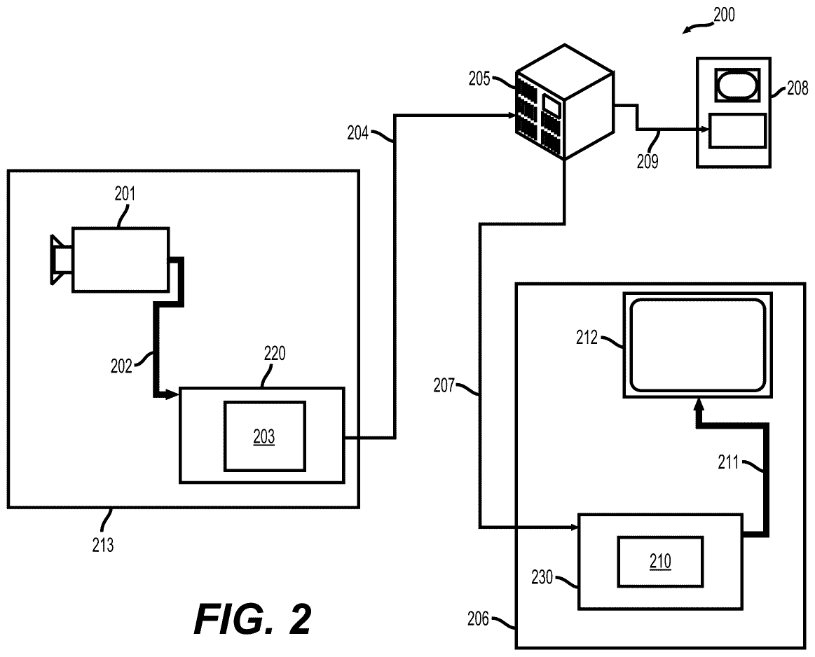

FIG. 2 shows a block diagram of a video processing system (200) in some examples. The video processing system (200) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (200) includes a capture subsystem (213), that can include a video source (201), for example a digital camera, creating for example a stream of video pictures (202) that are uncompressed. In an example, the stream of video pictures (202) includes samples that are taken by the digital camera. The stream of video pictures (202), depicted as a bold line to emphasize a high data volume when compared to encoded video data (204) (or coded video bitstreams), can be processed by an electronic device (220) that includes a video encoder (203) coupled to the video source (201). The video encoder (203) can include hardware, software, or a combination thereof to enable or implement aspects of the disclosed subject matter as described in more detail below. The encoded video data (204) (or encoded video bitstream), depicted as a thin line to emphasize the lower data volume when compared to the stream of video pictures (202), can be stored on a streaming server (205) for future use. One or more streaming client subsystems, such as client subsystems (206) and (208) in FIG. 2 can access the streaming server (205) to retrieve copies (207) and (209) of the encoded video data (204). A client subsystem (206) can include a video decoder (210), for example, in an electronic device (230). The video decoder (210) decodes the incoming copy (207) of the encoded video data and creates an outgoing stream of video pictures (211) that can be rendered on a display (212) (e.g., display screen) or other rendering device (not depicted). In some streaming systems, the encoded video data (204), (207), and (209) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (220) and (230) can include other components (not shown). For example, the electronic device (220) can include a video decoder (not shown) and the electronic device (230) can include a video encoder (not shown) as well.

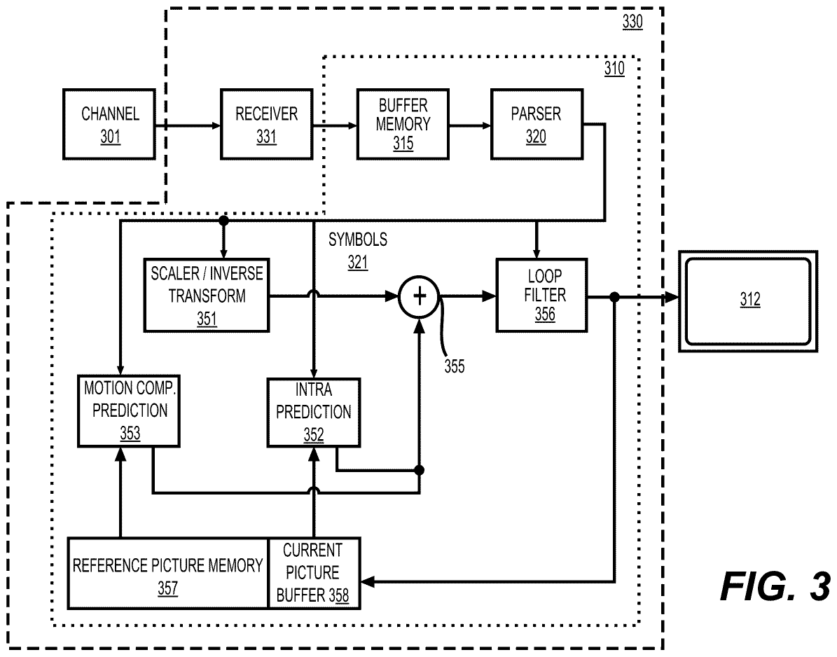

FIG. 3 shows a block diagram of a video decoder (310). The video decoder (310) can be included in an electronic device (330). The electronic device (330) can include a receiver (331) (e.g., receiving circuitry). The video decoder (310) can be used in the place of the video decoder (210) in the FIG. 2 example.

The receiver (331) can receive one or more coded video sequences, included in a bitstream for example, to be decoded by the video decoder (310). In an aspect, one coded video sequence is received at a time, where the decoding of each coded video sequence is independent from the decoding of other coded video sequences. The coded video sequence may be received from a channel (301), which may be a hardware/software link to a storage device which stores the encoded video data. The receiver (331) may receive the encoded video data with other data, for example, coded audio data and/or ancillary data streams, that may be forwarded to their respective using entities (not depicted). The receiver (331) may separate the coded video sequence from the other data. To combat network jitter, a buffer memory (315) may be coupled in between the receiver (331) and an entropy decoder/parser (320) (“parser (320)” henceforth). In certain applications, the buffer memory (315) is part of the video decoder (310). In others, it can be outside of the video decoder (310) (not depicted). In still others, there can be a buffer memory (not depicted) outside of the video decoder (310), for example to combat network jitter, and in addition another buffer memory (315) inside the video decoder (310), for example to handle playout timing. When the receiver (331) is receiving data from a store/forward device of sufficient bandwidth and controllability, or from an isosynchronous network, the buffer memory (315) may not be needed, or can be small. For use on best effort packet networks such as the Internet, the buffer memory (315) may be required, can be comparatively large and can be advantageously of adaptive size, and may at least partially be implemented in an operating system or similar elements (not depicted) outside of the video decoder (310).

The video decoder (310) may include the parser (320) to reconstruct symbols (321) from the coded video sequence. Categories of those symbols include information used to manage operation of the video decoder (310), and potentially information to control a rendering device such as a render device (312) (e.g., a display screen) that is not an integral part of the electronic device (330) but can be coupled to the electronic device (330), as shown in FIG. 3. The control information for the rendering device(s) may be in the form of Supplemental Enhancement Information (SEI) messages or Video Usability Information (VUI) parameter set fragments (not depicted). The parser (320) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (320) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (320) may also extract from the coded video sequence information such as transform coefficients, quantizer parameter values, motion vectors, and so forth.

The parser (320) may perform an entropy decoding/parsing operation on the video sequence received from the buffer memory (315), so as to create symbols (321).

Reconstruction of the symbols (321) can involve multiple different units depending on the type of the coded video picture or parts thereof (such as: inter and intra picture, inter and intra block), and other factors. Which units are involved, and how, can be controlled by subgroup control information parsed from the coded video sequence by the parser (320). The flow of such subgroup control information between the parser (320) and the multiple units below is not depicted for clarity.

Beyond the functional blocks already mentioned, the video decoder (310) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (351). The scaler/inverse transform unit (351) receives a quantized transform coefficient as well as control information, including which transform to use, block size, quantization factor, quantization scaling matrices, etc. as symbol(s) (321) from the parser (320). The scaler/inverse transform unit (351) can output blocks comprising sample values, that can be input into aggregator (355).

In some cases, the output samples of the scaler/inverse transform unit (351) can pertain to an intra coded block. The intra coded block is a block that is not using predictive information from previously reconstructed pictures, but can use predictive information from previously reconstructed parts of the current picture. Such predictive information can be provided by an intra picture prediction unit (352). In some cases, the intra picture prediction unit (352) generates a block of the same size and shape of the block under reconstruction, using surrounding already reconstructed information fetched from the current picture buffer (358). The current picture buffer (358) buffers, for example, partly reconstructed current picture and/or fully reconstructed current picture. The aggregator (355), in some cases, adds, on a per sample basis, the prediction information the intra prediction unit (352) has generated to the output sample information as provided by the scaler/inverse transform unit (351).

In other cases, the output samples of the scaler/inverse transform unit (351) can pertain to an inter coded, and potentially motion compensated, block. In such a case, a motion compensation prediction unit (353) can access reference picture memory (357) to fetch samples used for prediction. After motion compensating the fetched samples in accordance with the symbols (321) pertaining to the block, these samples can be added by the aggregator (355) to the output of the scaler/inverse transform unit (351) (in this case called the residual samples or residual signal) so as to generate output sample information. The addresses within the reference picture memory (357) from where the motion compensation prediction unit (353) fetches prediction samples can be controlled by motion vectors, available to the motion compensation prediction unit (353) in the form of symbols (321) that can have, for example X, Y, and reference picture components. Motion compensation also can include interpolation of sample values as fetched from the reference picture memory (357) when sub-sample exact motion vectors are in use, motion vector prediction mechanisms, and so forth.

The output samples of the aggregator (355) can be subject to various loop filtering techniques in the loop filter unit (356). Video compression technologies can include in-loop filter technologies that are controlled by parameters included in the coded video sequence (also referred to as coded video bitstream) and made available to the loop filter unit (356) as symbols (321) from the parser (320). Video compression can also be responsive to meta-information obtained during the decoding of previous (in decoding order) parts of the coded picture or coded video sequence, as well as responsive to previously reconstructed and loop-filtered sample values.

The output of the loop filter unit (356) can be a sample stream that can be output to the render device (312) as well as stored in the reference picture memory (357) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (320)), the current picture buffer (358) can become a part of the reference picture memory (357), and a fresh current picture buffer can be reallocated before commencing the reconstruction of the following coded picture.

The video decoder (310) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (331) may receive additional (redundant) data with the encoded video. The additional data may be included as part of the coded video sequence(s). The additional data may be used by the video decoder (310) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

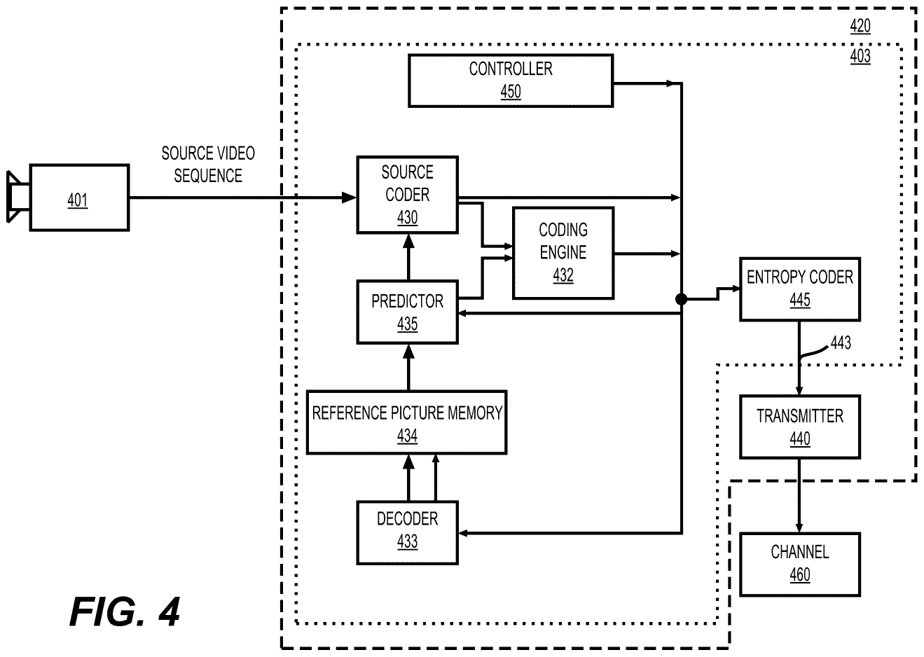

FIG. 4 shows an exemplary block diagram of a video encoder (403). The video encoder (403) is included in an electronic device (420). The electronic device (420) includes a transmitter (440) (e.g., transmitting circuitry). The video encoder (403) can be used in the place of the video encoder (203) in the FIG. 2 example.

The video encoder (403) may receive video samples from a video source (401) (that is not part of the electronic device (420) in the FIG. 4 example) that may capture video image(s) to be coded by the video encoder (403). In another example, the video source (401) is a part of the electronic device (420).

The video source (401) may provide the source video sequence to be coded by the video encoder (403) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (401) may be a storage device storing previously prepared video. In a videoconferencing system, the video source (401) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (403) may code and compress the pictures of the source video sequence into a coded video sequence (443) in real time or under any other time constraints as required. Enforcing appropriate coding speed is one function of a controller (450). In some aspects, the controller (450) controls other functional units as described below and is functionally coupled to the other functional units. The coupling is not depicted for clarity. Parameters set by the controller (450) can include rate control related parameters (picture skip, quantizer, lambda value of rate-distortion optimization techniques, . . . ), picture size, group of pictures (GOP) layout, maximum motion vector search range, and so forth. The controller (450) can be configured to have other suitable functions that pertain to the video encoder (403) optimized for a certain system design.

In some aspects, the video encoder (403) is configured to operate in a coding loop. As an oversimplified description, in an example, the coding loop can include a source coder (430) (e.g., responsible for creating symbols, such as a symbol stream, based on an input picture to be coded, and a reference picture(s)), and a (local) decoder (433) embedded in the video encoder (403). The decoder (433) reconstructs the symbols to create the sample data in a similar manner as a (remote) decoder also would create. The reconstructed sample stream (sample data) is input to the reference picture memory (434). As the decoding of a symbol stream leads to bit-exact results independent of decoder location (local or remote), the content in the reference picture memory (434) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (433) can be the same as a “remote” decoder, such as the video decoder (310), which has already been described in detail above in conjunction with FIG. 3. Briefly referring also to FIG. 3, however, as symbols are available and encoding/decoding of symbols to a coded video sequence by an entropy coder (445) and the parser (320) can be lossless, the entropy decoding parts of the video decoder (310), including the buffer memory (315), and parser (320) may not be fully implemented in the local decoder (433).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (430) may perform motion compensated predictive coding, which codes an input picture predictively with reference to one or more previously coded picture from the video sequence that were designated as “reference pictures.” In this manner, the coding engine (432) codes differences between pixel blocks of an input picture and pixel blocks of reference picture(s) that may be selected as prediction reference(s) to the input picture.

The local video decoder (433) may decode coded video data of pictures that may be designated as reference pictures, based on symbols created by the source coder (430). Operations of the coding engine (432) may advantageously be lossy processes. When the coded video data may be decoded at a video decoder (not shown in FIG. 4), the reconstructed video sequence typically may be a replica of the source video sequence with some errors. The local video decoder (433) replicates decoding processes that may be performed by the video decoder on reference pictures and may cause reconstructed reference pictures to be stored in the reference picture memory (434). In this manner, the video encoder (403) may store copies of reconstructed reference pictures locally that have common content as the reconstructed reference pictures that will be obtained by a far-end video decoder (absent transmission errors).

The predictor (435) may perform prediction searches for the coding engine (432). That is, for a new picture to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures. The predictor (435) may operate on a sample block-by-pixel block basis to find appropriate prediction references. In some cases, as determined by search results obtained by the predictor (435), an input picture may have prediction references drawn from multiple reference pictures stored in the reference picture memory (434).

The controller (450) may manage coding operations of the source coder (430), including, for example, setting of parameters and subgroup parameters used for encoding the video data.

Output of all aforementioned functional units may be subjected to entropy coding in the entropy coder (445). The entropy coder (445) translates the symbols as generated by the various functional units into a coded video sequence, by applying lossless compression to the symbols according to technologies such as Huffman coding, variable length coding, arithmetic coding, and so forth.

The transmitter (440) may buffer the coded video sequence(s) as created by the entropy coder (445) to prepare for transmission via a communication channel (460), which may be a hardware/software link to a storage device which would store the encoded video data. The transmitter (440) may merge coded video data from the video encoder (403) with other data to be transmitted, for example, coded audio data and/or ancillary data streams (sources not shown).

The controller (450) may manage operation of the video encoder (403). During coding, the controller (450) may assign to each coded picture a certain coded picture type, which may affect the coding techniques that may be applied to the respective picture. For example, pictures often may be assigned as one of the following picture types:
An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (403) may perform coding operations according to a predetermined video coding technology or standard, such as ITU-T Rec. H.266. In its operation, the video encoder (403) may perform various compression operations, including predictive coding operations that exploit temporal and spatial redundancies in the input video sequence. The coded video data, therefore, may conform to a syntax specified by the video coding technology or standard being used.

In an aspect, the transmitter (440) may transmit additional data with the encoded video. The source coder (430) may include such data as part of the coded video sequence. Additional data may comprise temporal/spatial/SNR enhancement layers, other forms of redundant data such as redundant pictures and slices, supplementary enhancement information (SEI) messages, Visual Usability Information (VUI) parameter set fragments, and so on.

Compressed video can be augmented, in the video bitstream, by supplementary enhancement information, for example in the form of Supplementary Enhancement Information (SEI) Messages or Video Usability Information (VUI). Video coding standards can include specifications parts for SEI and VUI. SEI and VUI information may also be specified in stand-alone specifications that may be referenced by the video coding specifications.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (203) and (403), and the video decoders (210) and (310) can be implemented using any suitable technique. In an aspect, the video encoders (203) and (403) and the video decoders (210) and (310) can be implemented using one or more integrated circuits. In another aspect, the video encoders (203) and (403), and the video decoders (210) and (310) can be implemented using one or more processors that execute software instructions.

In some aspects, some video codec, such as ITU and MPEG video codecs from 2003 onwards, H.264, H.265 and the like, do not use transient headers above the slice header. Instead, in some examples, some video codecs rely on parameter sets. On most syntactical levels, such as sequence level or picture level, one or more parameter sets can be received by a decoder from the bitstream or by external means. In some examples, many parameter sets are available at the decoder, which of the parameter sets of the same type are being used for the decoding of a given sequence or picture depends on the reference coded in, for example, the slice header (for the picture parameter set (PPS) or for the sequence parameter set (SPS)). This architecture can have the advantage that the relevant parameter sets can be reliably sent even if the bitstream itself is sent over a lossy channel, or that the likelihood of the reception of the parameter sets can be increased through the sending of redundant copies, potentially well in advance of the first use of the parameters sets. In an example, one disadvantage can be that the sending of a parameter set can be more costly, in terms of bits required for the same number and types of syntax elements, than the sending of MPEG-2 style headers (e.g., sequence header, group of picture headers and picture headers). Further, certain syntax elements that change frequently from picture to picture but stay constant within a given picture may, under this architecture, are included in the form of multiple redundant copies in each slice header. While doing so can make the slices independently decodable (at least from a parsing dependency end entropy decoding viewpoint), it can cost further bits.

As described above, parameter sets may not necessarily be delivered simultaneously with the delivery of coded picture data to a decoder process. The parameter sets may instead be delivered by an external means (for example, through external configuration parameters provided to a decoder process) or by parameter sets that are delivered to the decoder from within the bitstream but asynchronously from the delivery of the coded picture data. Thus, information that is carried in parameter sets can be regarded as essential to the interpretation of bits reconstructed from a coded picture, by a decoder, to produce individual video samples for presentation by a display, such information can be delivered asynchronously from the coded picture data in some examples.

Another technique used in video coding standards is the Supplemental Enhancement Information (SEI) message, the SEI message enables the carriage of information or metadata, within the coded bitstream, where such information or metadata may not be essential to the reconstruction of individual video samples, but may instead supplemental to the coded video sequence as a whole. For example, some applications may include a rendering process that follows the reconstruction of picture samples by a decoder. Such a rendering process may use certain SEI messages to adjust the brightness or color space of one or more of the decoded pictures prior to presentation by a display device.

SEI messages were originally designed so that the scope of the information carried within the message was relevant to precisely one picture. Hence the message itself may be regarded as metadata that is presented to the decoder synchronously with the coded picture data to which it is relevant. The design of newer SEI messages created during the development of HEVC and VVC ITU and MPEG video codecs, was modified to accommodate the need, in some cases, to repeat the same SEI message for multiple pictures. Thus, in some examples, a cancel option and a persistence option are added to newer SEI messages to enable the signaling of the precise scope for each SEI message, in terms of its relevance on portions of the video bitstream.

Yet another form of metadata support exists in the HEVC and VVC video codecs in the form of the Video Usability Information (VUI) syntax element. The VUI carries supplemental information pertaining to a coded video sequence, but when available, may be provided asynchronously to the coded picture data. The VUI may be conceptually independent from sequence level parameters required for decoding, but may be nevertheless part of the sequence parameter set (SPS) for convenience.

The aforementioned means of providing information to the decoder to guide the decoder in its reconstruction of video samples may be characterized as the following: 1) information that is essential for the decoder to correctly reconstruct the video samples and 2) information that is regarded as non-essential, i.e., the decoder may choose to ignore such information without compromising its ability to reconstruct the samples.

It is noted that the essential or non-essential information may be provided to the decoder either simultaneously or asynchronous to the delivery to the decoder of the coded picture data, i.e., the bits that will be reconstructed by the decoder to the video samples. In the case of simultaneous delivery, the essential or non-essential information may be located in header structures closely located to the coded picture data within the bitstream, or in SEI messages that are associated either with a single picture (for older SEI designs) or (through the mechanisms of the persistence and cancel flags for the newer SEI designs) to a contiguous portion of the video stream. In the case of asynchronous delivery the essential or non-essential information may be located in parameter sets or in the VUI, which may be provided within the bitstream or may be available to the decoder through external means.

According to an aspect, current video codec designs, including those developed by the ITU and MPEG including H.264|AVC, H.265|HEVC and H.266|VVC, as well as those developed by the Alliance for Open Media (AOM), including at present, AV1, may support scalable video in terms of layers, where a base layer is encoded to support a nominal SNR (signal to noise ratio), spatial resolution, or temporal resolution. In some aspects, the current video codec designs do not have a mechanism to efficiently signal metadata that is common across multiple individual layers of video. Some aspects of the present disclosure provide various techniques for providing information that may be essential for one or more layers.

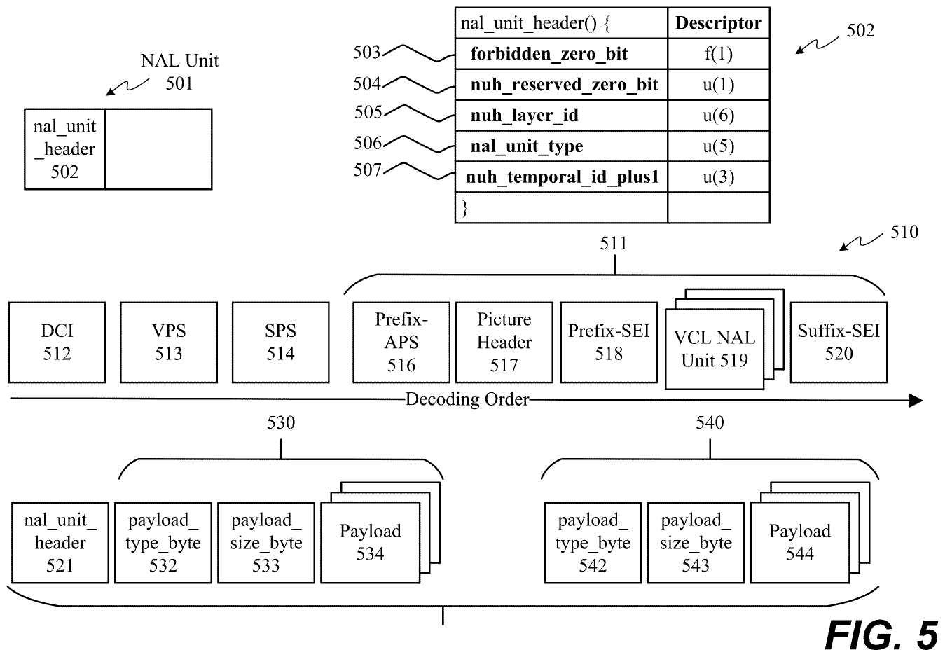

FIG. 5 shows a layout of a coded video sequence (CVS) in some examples, such as in accordance with H.266. The coded video sequence is subdivided into network abstraction layer units (NAL units), such as an NAL unit (501) in FIG. 5. In the FIG. 5 example, the NAL unit (501) can include a NAL unit header (502). In some examples, the NAL unit header (502) includes 16 bits. In the FIG. 5 example, the NAL unit header (502) includes a first bit of forbidden_zero_bit (503) and a second bit of nuh_reserved_zero_bit 504). In an example, the first bit and the second bit are unused by H.266 and are set to zero in a NAL unit compliant with H.266.

Further, in the FIG. 5 example, the NAL unit header (502) includes six bits of nuh_layer_id (505) that may be indicative of the (spatial, SNR, or multiview enhancement) layer to which the NAL unit (501) belongs to. Also, the NAL unit header (502) includes five bits of nuh_nal_unit_type (506) that define the type of NAL unit (501). In some examples (e.g., H.266), among the 32 values represented by the five bits, 22 NAL unit type values are defined for NAL unit types, six NAL unit types are reserved, and four NAL unit type values are unspecified and can be used by specifications other than H.266. Finally, the NAL unit header (502) includes three bits of nuh_temporal_id_plus1 (506) to indicate the temporal layer to which the NAL unit (501) belongs to.

NAL units are classified into video coding layer (VCL) and non-VCL NAL units. The VCL NAL units include the data that represents the values of the samples in the video pictures, and the non-VCL NAL units contain any associated additional information such as parameter sets and supplemental enhancement information (SEI).

In some examples, a coded picture can include one or more Video Coding Layer (VCL) NAL units and zero or more non-VCL NAL units. VCL NAL units may contain coded data conceptually belonging to a video coding layer as introduced before. Non-VCL NAL units may contain data conceptually belonging data not conceptually belonging to the video coding layer. Using H.266 as an example, the Non-VCL NAL units can be categorized into for example following 6 categories:
(1) Parameter sets, which include information that can be necessary for the decoding process and can be applied to more than one coded picture. Parameter sets and conceptually similar NAL units may be of NAL unit types, such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.
(2) Picture Header (PH_NUT), which is also a “normative” NAL unit.
(3) NAL units marking certain places in a NAL unit stream. The third category includes NAL units with the NAL unit types AUD_NUT (Access Unit Delimiter), EOS_NUT (End of Sequence) and EOB_NUT (End of Bitstream). The third category of NAL units are non-normative, also known as informative, in the sense that a compliant decoder does not require them for its decoding process, although it needs to be able to receive them in the NAL unit stream.
(4) Prefix and Suffix SEI Nal unit types (PREFIX_SEI_NUT and SUFFIX_SEI_NUT) which indicate NAL units containing Prefix and Suffix supplementary enhancement information. In some examples (e.g., in H.266), the fourth category of NAL units are informative, as they are not required for the decoding process.
(5) Filler Data NAL unit type FD_NUT indicates filler data; data that can be random and can be used to “waste” bits in a NAL unit stream or bitstream, which may be necessary for the transport over certain isochronous transport environments.
(6) Reserved and Unspecified NAL unit types.

FIG. 5 also shows a layout of a NAL unit stream (510) in a decoding order in some examples. The NAL unit stream (510) includes a coded picture (511). The NAL unit stream (510) includes, somewhere earlier than the coded picture (511), DCI (512), VPS (513), and SPS (514). DCI (512), VPS (513), and SPS (514) may, in combination, establish the parameters which the decoder can use to decode the coded pictures of a coded video sequence (CVS), including the coded picture (511) in the NAL unit stream (510).

In the FIG. 5 example, the coded picture (511) can include, in the depicted order or any other order compliant with the video coding technology or standard in use (such as H.266 in the present disclosure): a prefix APS (516), picture header (PH, 517), prefix SEI (518), one or more VCL NAL units (519), and suffix SEI (520).

In some examples, prefix and suffix SEI NAL units (518) and (520) are configured during the standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs allows avoiding buffering. For example, in an encoder, the sampling time of a picture to be coded is known before the picture is coded, and hence the picture timing SEI message can be a prefix SEI message (518). On the other hand, a decoded picture hash SEI message, which contains a hash of the sample values of a decoded pictures and can be useful, for example, to debug encoder implementations, is a suffix SEI message (520) as an encoder cannot calculate a hash over reconstructed samples before a picture has been coded. The location of prefix and suffix SEI NAL units may not be restricted to their position in the NAL unit stream. The phrase “prefix” and “suffix” may imply to what coded pictures or NAL units the prefix/suffix SEI message may pertain to, and the details of this applicability may be specified, for example in the semantics description of a given SEI message.

FIG. 5 also shows a diagram of a syntax of a NAL unit (551) that contains a prefix or suffix SEI message. The syntax is a container format for multiple SEI messages that can be carried in one NAL unit (also referred to as SEI NAL unit). Details of the emulation prevention syntax specified in H.266 are omitted here for clarity. As other NAL units, an SEI NAL unit starts with a NAL unit header (521). The NAL unit header (521) is followed by one or more SEI messages, such as a first SEI message (530) and a second SEI message (540) in FIG. 5. Each SEI message inside the NAL unit (551) includes an 8 bit payload_type_byte which specifies one of 256 different SEI types, such as shown by payload_type_byte (532) and payload_type_byte (542) in FIG. 5. Further, each SEI message inside the NAL unit (551) includes an 8 bit payload_size_byte which specifies the number of bytes of the SEI payload, such as shown by payload_size_byte (533) and payload_size_byte (543) in FIG. 5. Then, each SEI message inside the NAL unit (551) includes SEI payload with the number of bytes specified by payload_size_byte, such as the payload (534) and the payload (544). In some examples, the structure can be repeated until a payload_type_byte equal to 0xff is observed, which indicates the end of the NAL unit. The syntax of the payload depends on the SEI message, it can be of any length between 0 and 255 bytes.

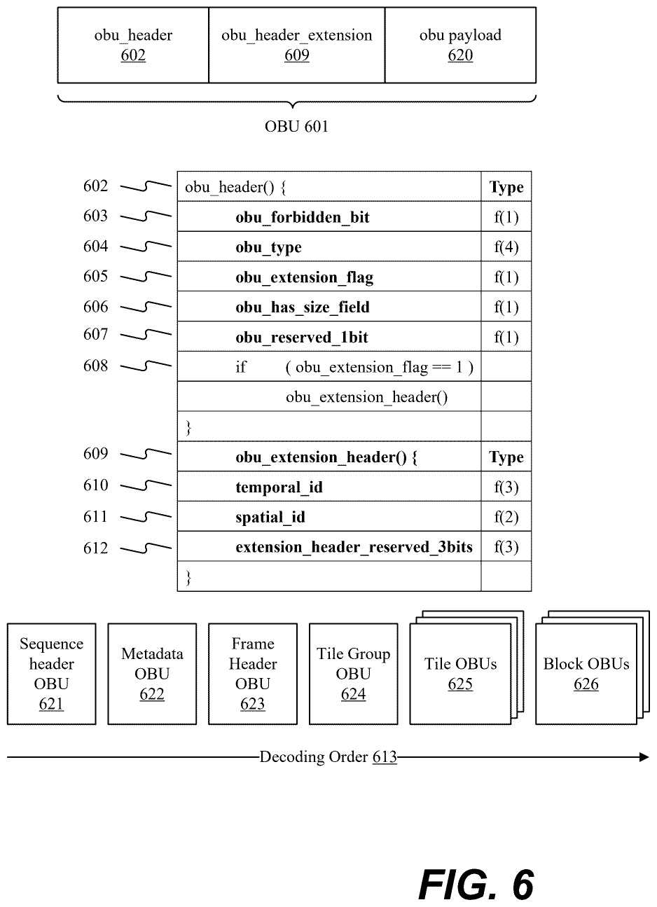

FIG. 6 shows a layout of a video bitstream (600) in some examples. The video bitstream (600) includes a series of Open Bitstream Units (OBUs) (601), for example in accordance with AV1. The video bitstream (600) can be used to create a video that referred to as OBU-based video in some examples. In the FIG. 6 example, an OBU (601) can include an OBU header (602), an OBU header extension (609), and a OBU payload (620) depending on the type of OBU. It is noted that some OBUs do not include the header extension (609).

The OBU header (602) includes a plurality of syntax elements. In the FIG. 6 example, the OBU header (602) starts with an obu_forbidden_bit (603) that may be unused in AV1 and may be set to zero in the OBU header (602). The OBU header (602) also includes obu_type (604) that signals the type of OBU payload (620) that follows the OBU header (602) or the OBU header extension (609). The OBU header (602) also includes obu_extension_flag (605) that indicates whether an OBU header extension (609) is in the OBU (601) and follows the OBU header (602). For example, when the obu_extension_flag (605) is equal to 1 (as shown by (608) in FIG. 6), then an obu_extension (609) follows the OBU header (602). When the obu_extension_flag (605) is not equal to 1, then an OBU payload (620) having a type indicated by obu_type (604) follows the OBU header (602).

In some examples, OBUs (601) of multiple types can be present in the video bitstream (600), the OBUs (601) can have respective types according to respective OBU type (604). In some examples, an OBU (601) can include a separate syntax element to indicate the size of the OBU payload (620) in the OBU (601). The presence of such a size indicator is signaled in the OBU header (602) by obu_has_size_field flag (606) as shown in FIG. 6. The OBU header (602) includes an additional obu_reserved_bit (607) for the purposes of byte-alignment of the OBU header (602). The obu_reserved_bit (607) may be unused in some examples and may be set to zero in the OBU header (602) in some examples.

FIG. 6 also shows a decoding order (613) of a sequence of OBUs of different types in some examples, such as in accordance with AV1. The decoding order (613) begins with a sequence header OBU (621) that can signal (include) information that is relevant for the entire sequence. In the FIG. 6 example, a metadata OBU (622) follows the sequence header OBU (621), the metadata OBU (622) can signal information that is relevant for following one or more frames. A frame header OBU (623) signals the start of a new frame which, in the parlance of other coding designs, may be synonymous to “picture.” The frame header OBU (623) includes information that is relevant to a following frame which includes a tile group OBU (624). The tile group OBU (624) includes information that is relevant to a group of tiles (also referred to as a tile group). The tile group OBU is referred to as tile group header OBU in some examples. Further, the tile group can be included as one or more tile OBUs (625). Each tile OBU can include information relevant to a tile that includes blocks. In some examples, the information of the blocks can be included as one or more block OBUs (626).

In some examples, frames can furthermore be layered to support scalability either in a spatial domain or a temporal domain, or both. For example, to support scalability, an OBU header (602) can be followed by an OBU extension header (609). The OBU extension header (609) can signal a temporal identifier (as shown by (610) in FIG. 6) to identify which temporal layer the following frames belong. Similarly, the OBU extension header (609) can include a spatial identifier (as shown by (611) in FIG. 6) that signals which spatial layer to which the following frames belong. The OBU extension header (609) can utilize reserved bits (as shown by (612) in FIG. 6) to ensure byte-alignment of the OBU extension header (609). The reversed bits may be unused in some examples and may also be set to zero in the OBU extension header (609) in some examples.

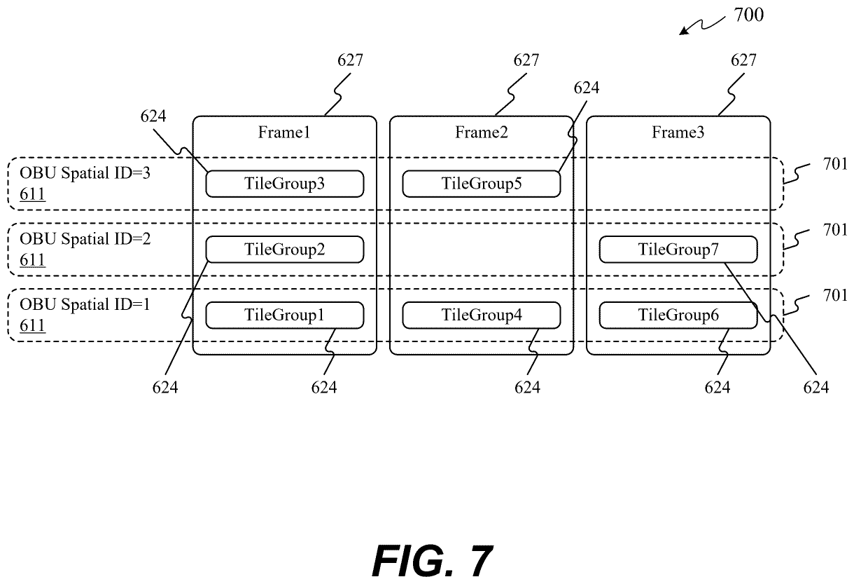

FIG. 7 shows a layout of a layered OBU-based video bitstream (700) in some aspects. The layered OBU-based video bitstream includes a series of frames (627) (also referred to as coded frames). In some examples, each frame (627) refers to tile groups (624) that are associated with a single, i.e., common, decoder output time (not shown). For example, the frame Frame1 can refer to tile groups TileGroup1, TileGroup2 and TileGroup3 that are associated with a first decoder output time; the frame Frame2 can refer to tile groups TileGroup4 and TileGroup5 that are associated with a second decoder output time; and the frame Frame3 can refer to tile groups TileGroup6 and TileGroup7 that are associated with a third decoder output time.

In some aspects, to support the concept of scalability, e.g., for spatial scalability, the layered OBU-based video bitstream (700) is further structured into layers (701), and each layer can be associated with an identifier, such as an OBU spatial identifier (611) in FIG. 7. In an example, OBUs associated with a layer can include an identifier of the layer that is non-zero. The OBU spatial identifier (611) can be signaled with the respective layer. In the FIG. 7 example, 3 layers that are represented by OBU spatial ID=1, OBU spatial ID=2, and OBU spatial ID=3 are shown. It is noted that to construct a layer in accordance with the current OBU-based video, all OBUs associated with a given layer, e.g., OBU spatial ID=1, have the same spatial layer ID of 1.

Referring to the FIG. 7 example, the OBU spatial layer 1 (e.g., OBU Spatial ID=1) includes 3 tile groups (624), such as the tile groups TileGroup1, TileGroup4, and TileGroup6; the OBU spatial layer 2 (e.g., OBU Spatial ID=2) includes two tile groups TileGroup2 and TileGroup7; the OBU spatial layer 3 (e.g., OBU Spatial ID=3) includes two tile groups TileGroup3 and TileGroup 5.

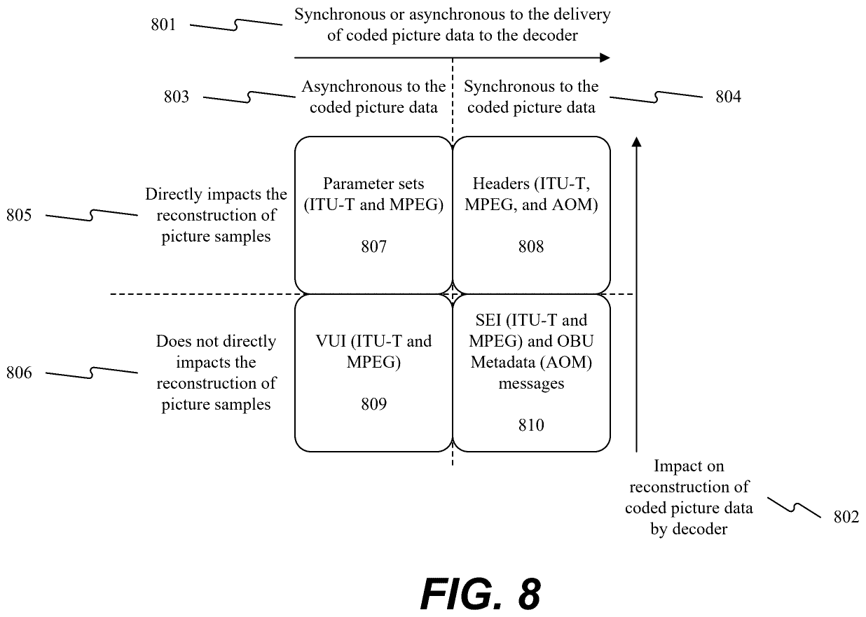

FIG. 8 shows a diagram of four categories (organized in quadrants) of high-level syntax structures in some examples. The four categories of high-level syntax structures are organized horizontally based on the aspects (801) of the timing and availability of the information to the decoder, such as shown by either (804) synchronously with the coded picture data, or (803) asynchronously to the coded picture data. The four categories of high-level syntax structures are organized vertically based on aspects (802) of the impact of the information to the reconstruction of sample values, such as shown by either (805) the information directly impacts the reconstruction of the picture sample values, or (806) does not indirectly impacts the reconstruction of the picture sample values.

Also shown in the FIG. 8 example, information that is in the upper-left of the quadrant, i.e., that directly impacts the reconstruction of the sample values, but is delivered asynchronously to the coded picture data, can include, for example parameter sets used in ITU-T and MPEG video codecs (807); information that is in the upper-right of the quadrant, i.e., that directly impacts the reconstruction of the sample values, but is delivered synchronously with the coded picture data includes, can include, for example header structures (e.g., picture headers, slice headers, sequence headers) used in ITU-T, MPEG, and AOM video codecs (808); information that is in the lower-left quadrant, i.e., that does not directly impact the reconstruction of the sample values, and is delivered asynchronously to the coded picture data, can include, for example the Video Usability Information (VUI) used in ITU-T and MPEG video codecs (809); and information that is in the lower-right quadrant, i.e., that does not directly impact the reconstruction of the picture samples, but is delivered synchronously with the coded picture data, can include, for example SEI messages used by ITU-T and MPEG video codecs, and OBU metadata used in AOM video codecs (810).

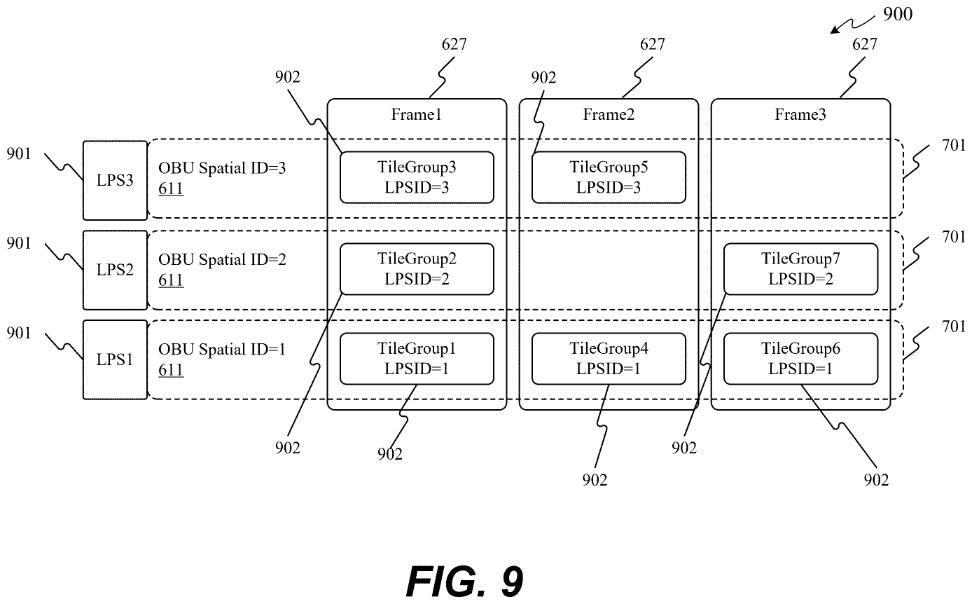

FIG. 9 shows an example of using the high level syntax information in FIG. 8. for a layered OBU-based video bitstream (900) that includes coded frames (also referred as frames), such as the coded frames (627) in FIG. 7.

In the FIG. 9 example, each coded frame (627) can refer to a plurality of tile groups (902) (also referred to as a plurality of tile group OBUs) that are associated with a single, i.e., common, decoder output time (not shown). For example, the coded frame Frame1 can refer to tile groups TileGroup1, TileGroup2 and TileGroup3 associated with a first decoder output time; the coded frame Frame2 can refer to tile groups TileGroup4 and TileGroup5 that are associated with a second decoder output time; and the coded frame Frame3 can refer to tile groups TileGroup6 and TileGroup7 that are associated with a third decoder output time. It is noted that TileGroup1, TileGroup2, TileGroup3, TileGroup4, TileGroup5, TileGroup6, and TileGroup7 can represent tile group OBUs (e.g., similar to the tile group OBU (624)). A coded frame can include other types of OBUs (not shown), such as tile OBUs, block OBUs, and the like.

In some aspects, to support the concept of scalability, e.g., for spatial scalability, the layered OBU-based video bitstream (900) is further structured into layers (701), and each layer can be associated with an OBU spatial identifier (611), the OBU spatial identifier (611) can be signaled with the respective layer. In the FIG. 9 example, a first OBU spatial layer, a second OBU spatial layer and a third OBU spatial layer are represented by OBU spatial ID=1, OBU spatial ID=2, and OBU spatial ID=3 respectively. It is noted that to construct a layer in accordance with the current OBU-based video, all OBUs associated with a given layer, e.g., OBU spatial ID=1, can have the same spatial layer ID of 1. For example, various types of OBUs (e.g., tile grout OBU, tile OBUs, block OBUs, and the like) associated with the first OBU spatial layer can include the OBU spatial ID=1; various types of OBUs (e.g., tile grout OBU, tile OBUs, block OBUs, and the like) associated with the second OBU spatial layer can include the OBU spatial ID=2; and various types of OBUs (e.g., tile grout OBU, tile OBUs, block OBUs, and the like) associated with the third OBU spatial layer can include the OBU spatial ID=3.

Referring to the FIG. 9 example, the first OBU spatial layer (e.g., OBU Spatial ID=1) includes 3 tile groups (902), such as the tile groups TileGroup1, TileGroup4, and TileGroup6; the second OBU spatial layer (e.g., OBU Spatial ID=2) includes two tile groups TileGroup2 and TileGroup7; the third OBU spatial layer (e.g., OBU Spatial ID=3) includes two tile groups TileGroup3 and TileGroup 5.

According to an aspect, in the FIG. 9 example, each spatial layer (701) is associated with a layer parameter set (LPS) (901) that includes a set of information to describe the tile groups OBUs (902) and other OBUs (not shown) within the respective spatial layer. The tile groups (902) in FIG. 9 differ from the tile groups (624) in FIG. 7, because the tile groups (902) include a reference to a layer parameter set (901). It is noted that other OBUs (not shown, such as tile OBUs, block OBUs, and the like) within each layer may also include references to the layer parameter set (901). In the FIG. 9 example, a first spatial layer with OBU spatial ID=1 is associated with a first layer parameter set LPS1; a second spatial layer with OBU spatial ID=2 is associated with a second layer parameter set LPS2; and a third spatial layer with OBU spatial ID=1 is associated with a third layer parameter set LPS3.

According to an aspect of the disclosure, in the FIG. 9 example, when a tile group OBU (902) is in a spatial layer (701) and needs to refer to a layer parameter set (901) associated with the spatial layer, the tile group OBU (902) can include an identifier of the layer parameter set (901) that is associated with the spatial layer. It is noted that, for a layer parameter set (901) that is associated with a layer, such as a spatial layer (701), the layer parameter set (901) includes an identifier of the layer parameter set and other information (not shown) for the spatial layer (701) that is common across OBUs (e.g., tile group OBUs (902)) within the spatial layer (701).

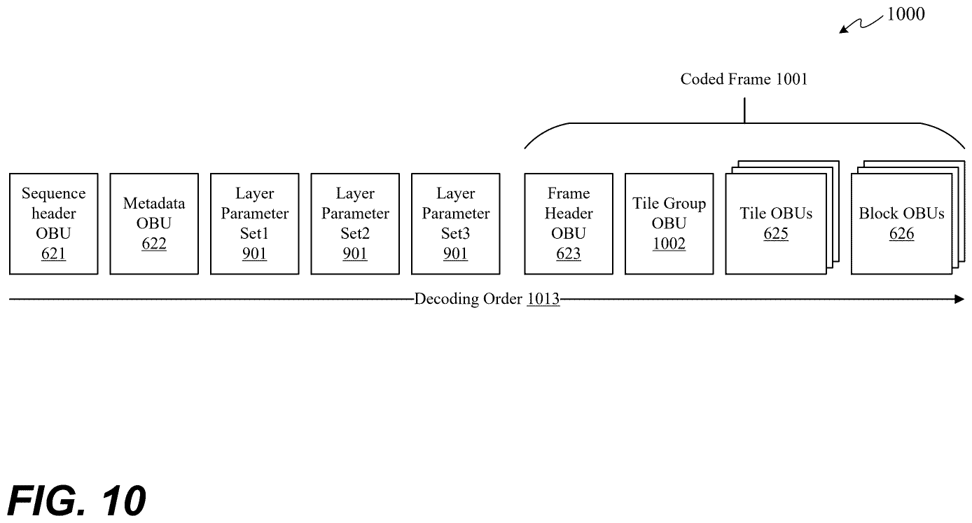

FIG. 10 shows a modified OBU sequence (1000) that uses layer parameter sets (901) to carry information that is constant for each layer (e.g., spatial layer, temporal layer, SNR layer, and the like). In the FIG. 10 example, the modified video sequence (1000) of OBUs is shown in a decoding order (1013) in accordance with some video codec examples, such as AV1. The modified video sequence (1000) begins with a sequence_header OBU (621) which may signal information that is relevant for the entire sequence (e.g., the modified video sequence (1000)). A metadata OBU (622) can follow the sequence_header OBU (621) to signal information that is relevant for the following frames (e.g., coded frames). In the FIG. 10 example, a series of 3 layer parameter sets (901) follow the metadata OBU (622), the layer parameter sets (901) are individual layer parameter sets respectively for a first layer, a second layer, and a third layer. For example, the layer parameter set1 of FIG. 10 corresponds to the layer parameter LPS1 in FIG. 9 and includes information for the first spatial layer that is identified as OBU spatial ID=1 in FIG. 9; the layer parameter set2 of FIG. 10 corresponds to the layer parameter LPS2 in FIG. 9 and includes information for the second spatial layer that is identified as OBU spatial ID=2 in FIG. 9; and the layer parameter set3 of FIG. 10 corresponds to the layer parameter LPS3 in FIG. 9 and includes information for the third spatial layer that is identified as OBU spatial ID=3 in FIG. 9.

In the FIG. 10 example, a frame header OBU (623) follows the series of three layer parameter sets (901), the frame header OBU (623) can be used to signal the start of a new frame (new coded frame) (1001). It is noted that, frame, in the parlance of other coding designs, may be synonymous to “picture.” The frame header OBU (623) includes information that is relevant to the coded frame (1001) which is comprised of a tile group OBU (1002). The tile group OBU (1002) can reference one of the layer parameter sets (e.g., the layer parameter set1, the layer parameter set2, the layer parameter set3). In an example, the tile group OBU (1002) is also named as a tile group header OBU for a group of tile OBUs. Further, the title group (or group of tiles) is comprised of one or more tile OBUs (625) which is likewise comprised of one or more block OBUs (626).

In an example, the layer parameter set1 in FIG. 10 corresponds to LPS1 in FIG. 9, the second parameter set2 in FIG. 10 corresponds to LPS2 in FIG. 9, and the layer parameter set3 in FIG. 10 corresponds to LPS3 in FIG. 9. When the coded frame (1001) of FIG. 10 corresponds to frame1 in FIG. 9, and the tile group OBU (1002) in FIG. 10 corresponds to TileGroup1 in FIG. 9, the tile group OBU (1002) can include an identifier (e.g., LPS1) of the layer parameter set1; when the tile group OBU (1002) in FIG. 10 corresponds to TileGroup2 in FIG. 9, the tile group OBU (1002) can include an identifier (e.g., LPS2) of the layer parameter set2; when the tile group OBU (1002) in FIG. 10 corresponds to TileGroup3 in FIG. 9, the tile group OBU (1002) can include an identifier (e.g., LPS3) of the layer parameter set3. When the coded frame (1001) of FIG. 10 corresponds to frame2 in FIG. 9, and the tile group OBU (1002) in FIG. 10 corresponds to TileGroup4 in FIG. 9, the tile group OBU (1002) can include an identifier (e.g., LPS1) of the layer parameter set1; when the tile group OBU (1002) in FIG. 10 corresponds to TileGroup5 in FIG. 9, the tile group OBU (1002) can include an identifier (e.g., LPS3) of the layer parameter set3. When the coded frame (1001) of FIG. 10 corresponds to frame3 in FIG. 9, and the tile group OBU (1002) in FIG. 10 corresponds to TileGroup6 in FIG. 9, the tile group OBU (1002) can include an identifier (e.g., LPS1) of the layer parameter set1; when the tile group OBU (1002) in FIG. 10 corresponds to TileGroup7 in FIG. 9, the tile group OBU (1002) can include an identifier (e.g., LPS2) of the layer parameter set2.

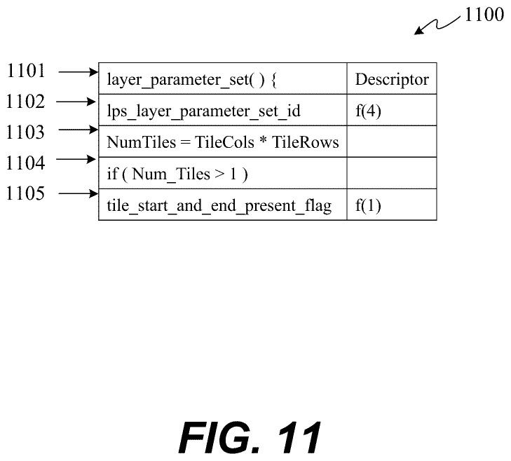

FIG. 11 shows a syntax structure (1100) of a layer parameter set in some examples. The syntax structure (1100) includes information that may remain consistent across layers, such as spatial layers (701). The syntax structure (1100) includes a plurality of lines (1101) to (1105). The line (1101) includes a label layer_parameter_set that indicates the syntax structure (1100) is a layer parameter set. The line (1102) shows that the layer parameter set includes an identifier of the layer parameter set itself. The line (1103) computes a variable called “NumTiles” by taking the product of two other variables: TileCols and TileRows. In an example, the variable TileCols is indicative of a number of tile columns in a tile group, the variable TileRows is indicative of a number tile rows in the tile group, and the variable NumTiles is indicative of a number of tiles in the tile group. The line (1104) tests the variable NumTiles to determine whether the value of the variable NumTiles is greater than one. If the value of the variable NumTiles is greater than one, then the line (1105) is executed to read a flag labeled “tile_state_and_end_present.”

It is noted that FIG. 11 shows a limited set of information that may be processed for a layer for example. In some other examples (not shown), OBUs associated with the layer may have other information that is likely to remain constant across the layer, the other information can be suitably included in a syntax structure for a layer parameter set, such as the syntax structure (1100).

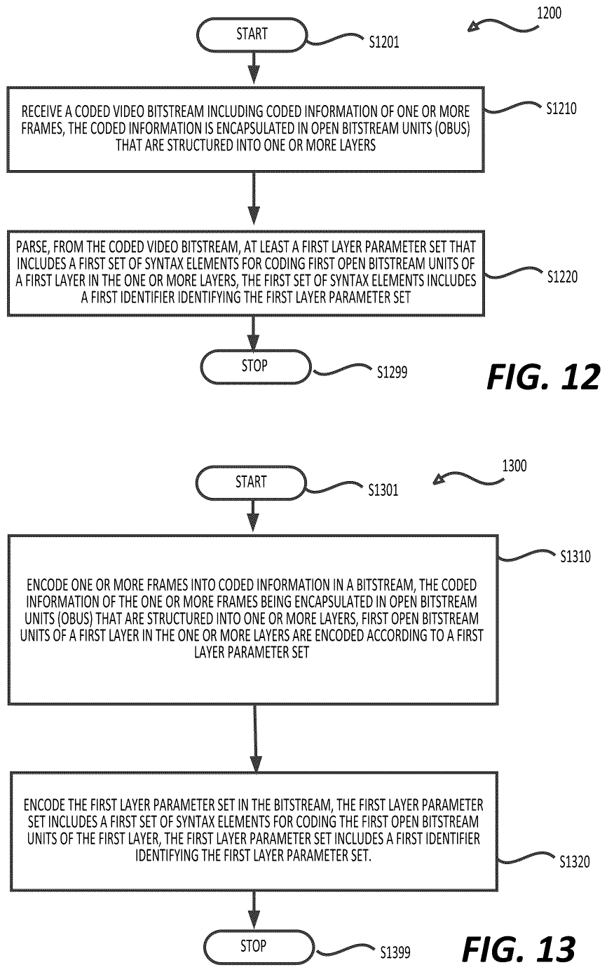

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a coded video bitstream is received. The coded video bitstream includes coded information of one or more frames, the coded information of the one or more frames is encapsulated in open bitstream units (OBUs) that are structured into one or more layers.

At (S1220), from the coded video bitstream, at least a first layer parameter set is parsed. The first layer parameter set includes a first set of syntax elements for coding (encoding and/or decoding) first open bitstream units of a first layer in the one or more layers, the first set of syntax elements includes a first identifier identifying the first layer parameter set.

In an aspect, the one or more layers comprises at least one of one or more spatial layers, one or more temporal layers, and/or one or more signal noise ratio (SNR) enhancement layers.

In some aspects, each of the first open bitstream units includes the first identifier that references to the first layer parameter set.

In some aspects, the first open bitstream units include one or more tile group open bitstream units. In some aspects, the first open bitstream units include one or more tile open bitstream units. In some aspects, the first open bitstream units include one or more block open bitstream units.

In some examples, at least a first picture in the first layer is reconstructed from the first open bitstream units according to the first layer parameter set.

In some aspects, a second layer parameter set is parsed from the coded video bitstream. The second layer parameter set includes a second set of syntax elements for coding (encoding and/or decoding) at least second open bitstream units of a second layer in the one or more layers, the second set of syntax elements includes a second identifier identifying the second layer parameter set.

In some examples, the first set of syntax elements includes a number of tiles in each frame of the first layer. In an example, the number of tiles is calculated as a product of a first number of tile rows and a second number of tile columns in each frame of the first layer. It is noted that a frame can have different numbers of rows and/or columns in different layers, and then can have different number of tiles in different layers.

In some examples, when the number of tiles is greater than zero, the first set of syntax elements includes a flag that indicates whether a start and an end of each tile are present.

Then, the process proceeds to (S1299) and terminates.

The process (1200) can be suitably adapted. Step(s) in the process (1200) can be modified and/or omitted. Additional step(s) can be added. Any suitable order of implementation can be used.

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), one or more frames are encoded into coded information in a bitstream, the coded information of the one or more frames is encapsulated in open bitstream units (OBUs) that are structured into one or more layers, first coded information in first open bitstream units of a first layer in the one or more layers are encoded according to a first layer parameter set.

At (S1320), the first layer parameter set is encoded in the bitstream, the first layer parameter set includes a first set of syntax elements for coding (encoding/decoding) the first open bitstream units of the first layer, the first layer parameter set includes a first identifier identifying the first layer parameter set.

In some aspects, the one or more layers include at least one of one or more spatial layers, one or more temporal layers, and/or one or more signal noise ratio (SNR) enhancement layers.

In some examples, the first identifier is included respectively with the first open bitstream units of the first layer in the bitstream.

In some examples, the first open bitstream units include one or more tile group open bitstream units. In some examples, the first open bitstream units include one or more tile open bitstream units. In some examples, the first open bitstream units include one or more block open bitstream units.

In some examples, a second layer parameter set is encoded into the bitstream, the second layer parameter set includes a second set of syntax elements for coding (encoding/decoding) second open bitstream units of a second layer in the one or more layers, the second set of syntax elements includes a second identifier identifying the second layer parameter set.

In some examples, the first set of syntax elements comprises a number of tiles in each frame of the first layer. For example, the number of tiles is calculated as a product of a first number of tile rows and a second number of tile columns in each frame of the first layer. In an example, when the number of tiles is greater than zero, the first set of syntax elements includes a flag that indicates whether a start position and an end position of each tile are present in the tile information in the bitstream.

Then, the process proceeds to (S1399) and terminates.

The process (1300) can be suitably adapted. Step(s) in the process (1300) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of one or more frames, the coded information of the one or more frames is encapsulated in open bitstream units (OBUs) that are structured into one or more layers. The format rule specifies, from the bitstream, at least a first layer parameter set is parsed, the first layer parameter set includes a first set of syntax elements for coding first open bitstream units of a first layer in the one or more layers, the first set of syntax elements includes a first identifier identifying the first layer parameter set.

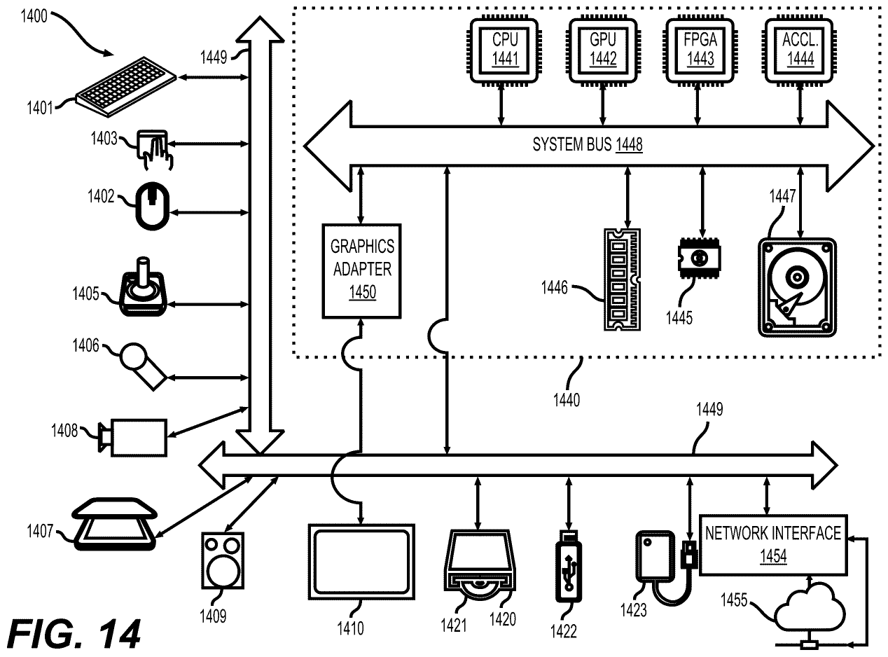

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features can be combined in various manners and are not limited to the combinations noted below.
(1). A method of video decoding, including: receiving a coded video bitstream including coded information of one or more frames, the coded information of the one or more frames being encapsulated in open bitstream units (OBUs) that are structured into one or more layers; and parsing, from the coded video bitstream, at least a first layer parameter set that includes a first set of syntax elements for coding first open bitstream units of a first layer in the one or more layers, the first set of syntax elements including a first identifier identifying the first layer parameter set.
(2). The method of feature (1), in which the one or more layers includes at least one of: one or more spatial layers, one or more temporal layers, and/or one or more signal noise ratio (SNR) enhancement layers.
(3). The method of any of features (1) to (2), further including: parsing, from each of the first open bitstream units, the first identifier that references to the first layer parameter set.
(4). The method of any of features (1) to (3), in which the first open bitstream units include at least one of: one or more tile group open bitstream units, one or more tile open bitstream units, and/or one or more block open bitstream units.
(5). The method of any of features (1) to (4), further including at least one of: reconstructing at least a first picture in the first layer from the first open bitstream units according to the first layer parameter set.

(6). The method of any of features (1) to (5), further including: parsing, from the coded video bitstream, a second layer parameter set that includes a second set of syntax elements for decoding at least second open bitstream units of a second layer in the one or more layers, the second set of syntax elements including a second identifier identifying the second layer parameter set.
(7). The method of any of features (1) to (6), in which the first set of syntax elements includes a number of tiles in each frame of the first layer.
(8). The method of any of features (1) to (7), in which the number of tiles is calculated as a product of a first number of tile rows and a second number of tile columns in each frame of the first layer.
(9). The method of any of features (1) to (8), in which when the number of tiles is greater than zero, the first set of syntax elements includes a flag that indicates whether a start position and an end position of each tile are present.
(10). A method of video encoding, including: encoding one or more frames into coded information in a bitstream, the coded information of the one or more frames being encapsulated in open bitstream units (OBUs) that are structured into one or more layers, first coded information in first open bitstream units of a first layer in the one or more layers being encoded according to a first layer parameter set; and encoding the first layer parameter set in the bitstream, the first layer parameter set including a first set of syntax elements for coding the first open bitstream units of the first layer, the first layer parameter set including a first identifier identifying the first layer parameter set.
(11). The method of feature (10), in which the one or more layers includes at least one of: one or more spatial layers, one or more temporal layers, and/or one or more signal noise ratio (SNR) enhancement layers.
(12). The method of any of features (10) to (11), further including: including the first identifier respectively with the first open bitstream units of the first layer in the bitstream.
(13). The method of any of features (10) to (12), in which the first open bitstream units include at least one of: one or more tile group open bitstream units, one or more tile open bitstream units, and/or one or more block open bitstream units.
(14). The method of any of features (10) to (13), further including: encoding a second layer parameter set into the bitstream, the second layer parameter set including a second set of syntax elements for coding second open bitstream units of a second layer in the one or more layers, the second set of syntax elements including a second identifier identifying the second layer parameter set.
(15). The method of any of features (10) to (14), in which the first set of syntax elements includes a number of tiles in each frame of the first layer.
(16). The method of any of features (10) to (15), in which the number of tiles is calculated as a product of a first number of tile rows and a second number of tile columns in each frame of the first layer.
(17). The method of any of features (10) to (16), in which when the number of tiles is greater than zero, the first set of syntax elements includes a flag that indicates whether a start position and an end position of each tile are present.
(18). A non-transitory computer readable storage medium storing a bitstream that is encoded by an encoding method, the encoding method including: encoding one or more frames into coded information in a bitstream, the coded information of the one or more frames being encapsulated in open bitstream units (OBUs) that are structured into one or more layers, first open bitstream units of a first layer in the one or more layers being encoded according to a first layer parameter set; encoding the first layer parameter set in the bitstream, the first layer parameter set including a first set of syntax elements for coding the first open bitstream units of the first layer, the first layer parameter set including a first identifier identifying the first layer parameter set; and transmitting the bitstream.
(19). An apparatus for video decoding, including processing circuitry that is configured to perform the method of any of features (1) to (9).
(20). An apparatus for video encoding, including processing circuitry that is configured to perform the method of any of features (10) to (17).
(21). A non-transitory computer-readable storage medium storing instructions which when executed by at least one processor cause the at least one processor to perform the method of any of features (1) to (17).

What is claimed is:

1. A method of video decoding, comprising:
receiving a coded video bitstream comprising coded information of one or more frames, the coded information of the one or more frames being encapsulated in open bitstream units (OBUs) that are structured into one or more layers; and
parsing, from the coded video bitstream, at least a first layer parameter set that comprises a first set of syntax elements for coding first open bitstream units of a first layer in the one or more layers, the first set of syntax elements comprising a first identifier identifying the first layer parameter set.

2. The method of claim 1, wherein the one or more layers comprises at least one of: one or more spatial layers, one or more temporal layers, and/or one or more signal noise ratio (SNR) enhancement layers.

3. The method of claim 1, further comprising:
parsing, from each of the first open bitstream units, the first identifier that references to the first layer parameter set.

4. The method of claim 3, wherein the first open bitstream units comprise at least one of:
one or more tile group open bitstream units,
one or more tile open bitstream units, and/or
one or more block open bitstream units.

5. The method of claim 1, further comprising at least one of:
reconstructing at least a first picture in the first layer from the first open bitstream units according to the first layer parameter set.

6. The method of claim 1, further comprising:
parsing, from the coded video bitstream, a second layer parameter set that comprises a second set of syntax elements for decoding at least second open bitstream units of a second layer in the one or more layers, the second set of syntax elements comprising a second identifier identifying the second layer parameter set.

7. The method of claim 1, wherein the first set of syntax elements comprises a number of tiles in each frame of the first layer.

8. The method of claim 7, wherein the number of tiles is calculated as a product of a first number of tile rows and a second number of tile columns in each frame of the first layer.

9. The method of claim 7, wherein when the number of tiles is greater than zero, the first set of syntax elements comprises a flag that indicates whether a start position and an end position of each tile are present.

10. A method of video encoding, comprising:
encoding one or more frames into coded information in a bitstream, the coded information of the one or more frames being encapsulated in open bitstream units (OBUs) that are structured into one or more layers, first coded information in first open bitstream units of a first layer in the one or more layers being encoded according to a first layer parameter set; and
encoding the first layer parameter set in the bitstream, the first layer parameter set comprising a first set of syntax elements for coding the first open bitstream units of the first layer, the first layer parameter set comprising a first identifier identifying the first layer parameter set.

11. The method of claim 10, wherein the one or more layers comprises at least one of: one or more spatial layers, one or more temporal layers, and/or one or more signal noise ratio (SNR) enhancement layers.

12. The method of claim 10, further comprising:
including the first identifier respectively with the first open bitstream units of the first layer in the bitstream.

13. The method of claim 12, wherein the first open bitstream units comprise at least one of:
one or more tile group open bitstream units,
one or more tile open bitstream units, and/or
one or more block open bitstream units.

14. The method of claim 10, further comprising:
encoding a second layer parameter set into the bitstream, the second layer parameter set comprising a second set of syntax elements for coding second open bitstream units of a second layer in the one or more layers, the second set of syntax elements comprising a second identifier identifying the second layer parameter set.

15. The method of claim 10, wherein the first set of syntax elements comprises a number of tiles in each frame of the first layer.

16. The method of claim 15, wherein the number of tiles is calculated as a product of a first number of tile rows and a second number of tile columns in each frame of the first layer.

17. The method of claim 15, wherein when the number of tiles is greater than zero, the first set of syntax elements comprises a flag that indicates whether a start position and an end position of each tile are present.

18. A non-transitory computer-readable storage medium storing instructions which when executed by a processor cause the processor to perform an encoding method, the encoding method comprising:
encoding one or more frames into coded information in a bitstream, the coded information of the one or more frames being encapsulated in open bitstream units (OBUs) that are structured into one or more layers, first open bitstream units of a first layer in the one or more layers being encoded according to a first layer parameter set;
encoding the first layer parameter set in the bitstream, the first layer parameter set comprising a first set of syntax elements for coding the first open bitstream units of the first layer, the first layer parameter set comprising a first identifier identifying the first layer parameter set; and
transmitting the bitstream.

19. The non-transitory computer-readable storage medium of claim 18, wherein the encoding method further comprises:
including the first identifier respectively with the first open bitstream units of the first layer in the bitstream.

20. The non-transitory computer-readable storage medium of claim 18, wherein the first open bitstream units comprise at least one of:
one or more tile group open bitstream units,
one or more tile open bitstream units, and/or
one or more block open bitstream units.
